(19) United States
(12) Patent Application Publication
(10) Pub. No.: US 2007/0226355 A1
(43) Pub. Date: Sep. 27, 2007

(54) Automated document processing with third party input

(75) Inventor: George William Luckhardt, San Diego, CA (US)

Correspondence Address: George W. Luckhardt, PO Box 927951, San Diego, CA, 92192, US

(73) Assignee: IP Filepoint, LLC

(21) Appl. No.: 11/711,359

(22) Filed: Feb. 27, 2007

Related U.S. Application Data
(63) Continuation-in-part of application No. 11/386,421, filed on Mar. 22, 2006.

(51) Int. Cl. G06F 15/16

(52) U.S. Cl. 709/227

(57) ABSTRACT

Automated document processing with third party input is described. A method for processing a document includes receiving a news story request from a client terminal at a server terminal, processing the news story request at the server terminal, generating a news story request response at the server terminal, and transmitting news story request response from the server terminal to the client terminal. The processing of the news story request at the server terminal may further include mapping a trend with respect to reporting of a news story by at least one news outlet. The processing of the news story request at the server terminal may further include identifying a similarity or difference with respect to news stories reported across different news outlets. The processing of the news story request at the server terminal may further include selecting a news story from a news outlet to be provided to a user.

### CROSS-REFERENCE, PRIORITY CLAIM AND INCORPORATION BY REFERENCE

This application is a continuation-in-part of, claims priority to, and incorporates by reference U.S. patent application Ser. No. 11/386,421 (Atty. Docket No. IPFP-P001), with a filing date of Mar. 22, 2006.

### FIELD

The invention relates generally to the field of document processing and, more specifically, to automated document processing.

### BACKGROUND

Official documents, such as tax return forms, may be time consuming to prepare and file with the appropriate agency, e.g. the Internal Revenue Service (IRS). Typically, a paper copy of the form is obtained by the tax filer. The paper form must then be filled out, either by handwriting or typing. Because the paper form must be handwritten or typed, many problems such as illegibility and typographical errors may arise.

Several software applications, such as Turbo Tax®, have been developed to enable the tax filer to fill out the tax forms electronically, e.g. using a personal computer, and file the tax forms electronically, e.g. using an Internet connection. Turbo Tax® prompts the tax filer for answers to various questions and fills out the tax form in response to the answers from the tax filer. Once the tax return is prepared, the tax filer submits the return to the IRS using Turbo Tax® via the Internet connection. However, after submission by the tax filer, the tax form is not reviewed or certified by an agent of Turbo Tax® before the tax form is received by the IRS.

Another type of official document is a patent application. Related to patent application filings, the US Patent and Trademark Office (USPTO) has implemented the Patent Electronic Filing System (EFS) which enables patent application filers to electronically file a US patent application with the USPTO. In usage of EFS, only two parties are involved. The first or sending party is the patent application filer, and the second or receiving party is the USPTO. Thus, all of the EFS required steps for the filing of the patent application must be performed by the sending party, e.g. the patent application filer. Therefore, there is no way for a third party, e.g. a patent attorney, to perform intermediate services, such as certification, in the filing of the patent application on behalf of the first party, e.g. an inventor or invention owner, such as when the client and the patent attorney geographically distant from each other.

For certain patent related filings, such as a Request for Continued Examination (RCE), the filing may be made later if faxed from a later time zone with a Certificate of Facsimile Transmission. However, the unavailability of third party services in execution of the EFS sacrifices utilization of services provided in other geographic areas, e.g. other time zones. Furthermore, the EFS is available only for limited types of patent documents, such as initial patent application filings.

Furthermore, news-related documents from around the world are not readily analyzed or delivered to remote users.

Therefore, there is a need for electronic document processing involving a third party.

### SUMMARY

Accordingly, the present invention is directed to automatic document processing with third party input that overcomes one or more problems due to limitations and disadvantages of the related art.

A method for document processing, according to an embodiment of the present invention, includes receiving a first document input from a user at a first terminal, and transmitting the first document input to a second terminal. The method also includes receiving, at the second terminal, a second document input from a reviewer based on the first document input, and transmitting information related to the first document input and the second document input to a third terminal.

In one aspect of the present invention, the first document input may be associated with a patent application. The method may further include prompting the user for the first document input at the first terminal. The second document input may include a certification of the first document input by the reviewer. The reviewer may be a patent agent or a patent attorney. The method may further include processing and/or formatting the first and/or second document inputs before the transmission to the third terminal.

In another aspect of the present invention, the second terminal is located in Hawaii. The third terminal may be affiliated with the US Patent and Trademark Office (USPTO). In another aspect of the present invention, the second terminal is located in an earlier time zone than the first terminal. The transmitting of the first document input to the second terminal and the transmitting of the information related to the first document input and the second document input to the third terminal may be performed using the Internet, and the first document input and the second document input may be received at the third terminal as a facsimile.

In another aspect, a method for processing a document includes receiving a news story request from a client terminal at a server terminal. The method also includes processing the news story request at the server terminal. The method also includes generating a news story request response at the server terminal. The method also includes transmitting news story request response from the server terminal to the client terminal. The processing of the news story request at the server terminal may further include mapping a trend with respect to reporting of a news story by at least one news outlet. The processing of the news story request at the server terminal may further include identifying a similarity with respect to news stories reported across different news outlets. The processing of the news story request at the server terminal may further include identifying a difference with respect to news stories reported across different news outlets. The processing of the news story request at the server terminal may further include selecting a news story from a news outlet to be provided to a user. The news story may be provided to the user as an online certificate. Alternatively, the news story may be provided to the user as a plaque.

In another aspect, a method for processing a document includes receiving a news story from a news outlet terminal at a server terminal. The method also includes processing the news story at the server terminal. The method also includes incorporating the news story into a database at the server terminal. The processing of the news story at the server terminal may further include assigning a priority to a news story. The processing of the news story at the server terminal may further include translating news stories to a uniform language. The processing of the news story at the server terminal may further include transcribing a news story broadcast on radio or television.

In another aspect, a method for processing a document includes receiving a news story from a news outlet terminal at a server terminal. The method also includes processing the news story at the server terminal. The method also includes incorporating the news story into a database at the server terminal. The method also includes receiving a news story request from a client terminal at the server terminal. The method also includes processing the news story request at the server terminal. The method also includes generating a news story request response at the server terminal based on information stored in the database. The method also includes transmitting news story request response from the server terminal to the client terminal. The processing of the news story request at the server terminal may further include mapping a trend with respect to reporting of a news story by at least one news outlet. The processing of the news story request at the server terminal may further include identifying a similarity with respect to news stories reported across different news outlets. The processing of the news story request at the server terminal may further include identifying a difference with respect to news stories reported across different news outlets. The processing of the news story request at the server terminal may further include selecting a news story from a news outlet to be provided to a user. The news story may be provided to the user as a plaque. The processing of the news story at the server terminal may further include assigning a priority to a news story. The processing of the news story at the server terminal may further include translating news stories to a uniform language. The mapping a trend with respect to reporting of a news story by at least one news outlet may be based on a priority assigned to the news story.

Advantages of the present invention include enabling a third party to provide input, such as review and/or certification, to a document submission. Additionally, if the document is a patent document, and the second terminal is located in Hawaii, the user may benefit from a later effective filing deadline for the patent document by the inclusion of a certificate of facsimile transmission asserting that the patent document was sent via facsimile to the USPTO before midnight, Hawaii Time. Furthermore, a wider range of patent documents may be processed using the present invention than using the EFS. Additionally, because of user prompting and data reformatting, the end user may submit documents through a straightforward question and answer dialog. In addition to patent documents, the present invention may also be utilized to process other types of time-critical, official, legal, medical or other types of documents. Additional advantages of the present invention include the ability to perform analysis on news stories from one or more news outlets.

### BRIEF DESCRIPTION OF THE INVENTION

The accompanying drawings, which are included to provide a further understanding of the invention and are incorporated in and constitute a part of this application, illustrate embodiments of the invention and together with the description serve to explain the principles of the invention.

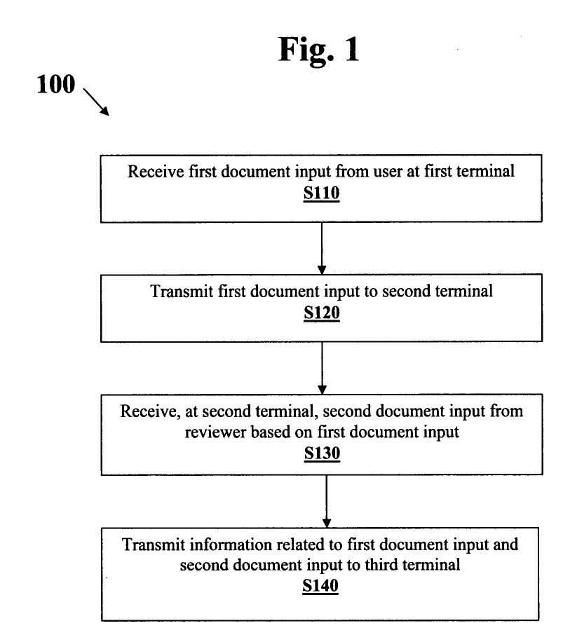

FIG. 1 is a flow diagram illustrating a method for document processing, according to an embodiment of the present invention.

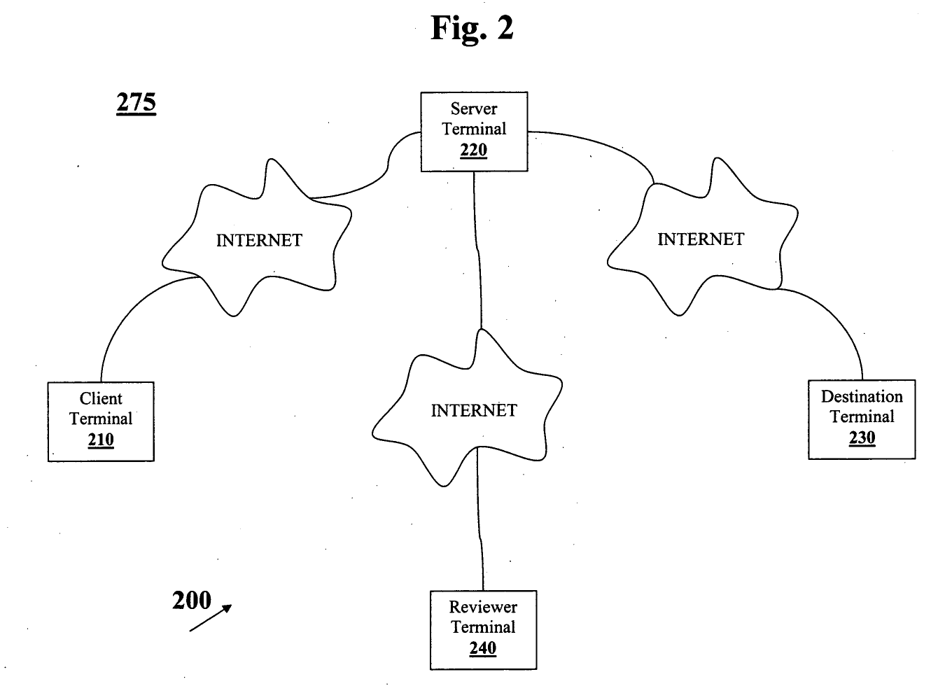

FIG. 2 is a block diagram illustrating an exemplary system for performing the methods of the present invention, operating in an exemplary environment, according to an embodiment of the present invention.

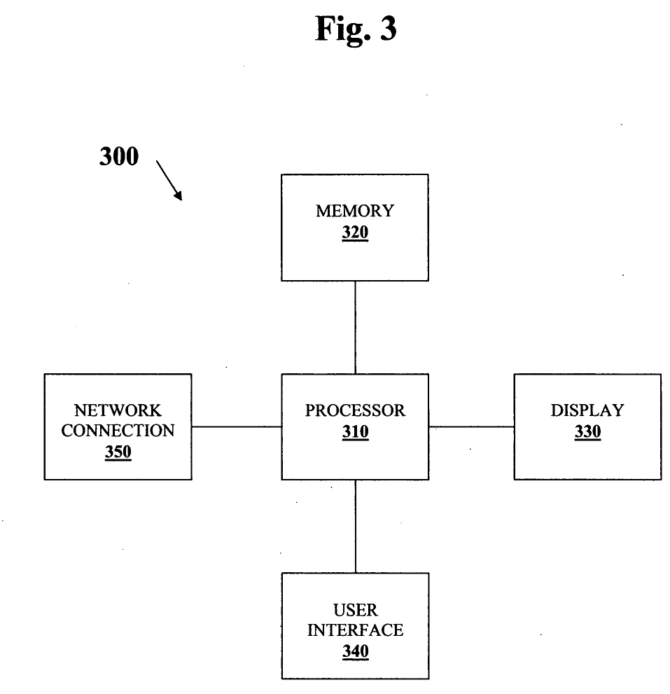

FIG. 3 is a block diagram illustrating an exemplary terminal for use in performing the methods of the present invention, according to an embodiment of the present invention.

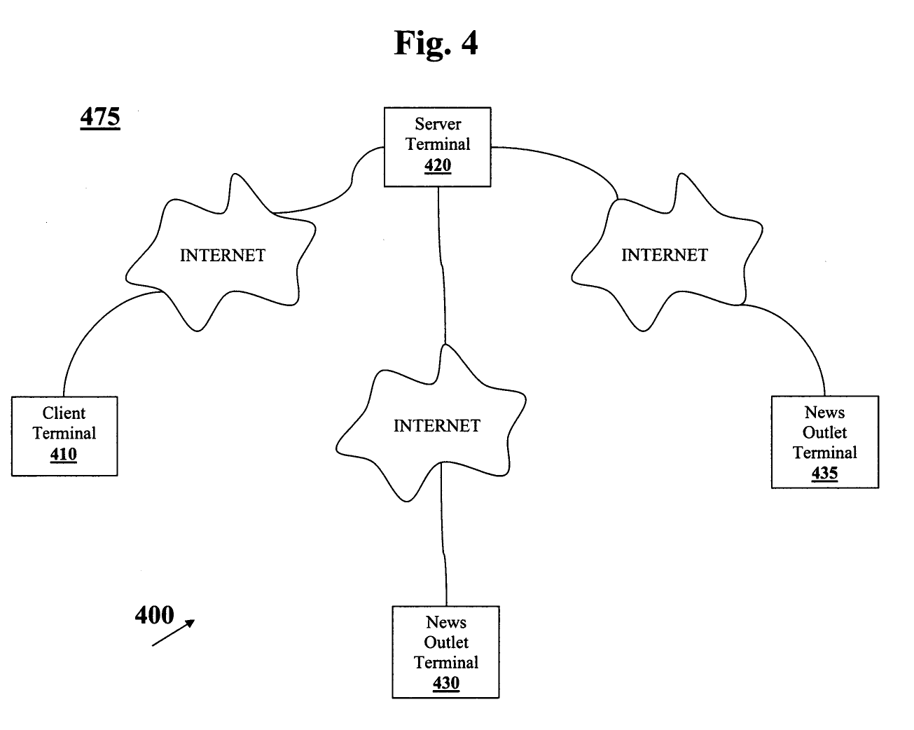

FIG. 4 is a block diagram illustrating an exemplary system for performing the methods of the present invention, operating in an exemplary environment, according to another embodiment of the present invention.

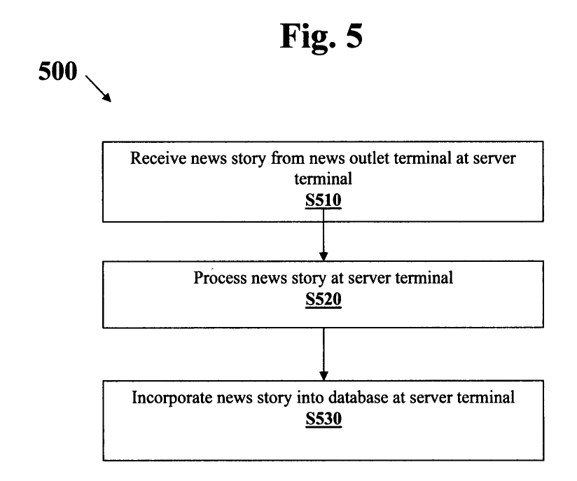

FIG. 5 is a flow diagram illustrating another method for document processing, according to an embodiment of the present invention.

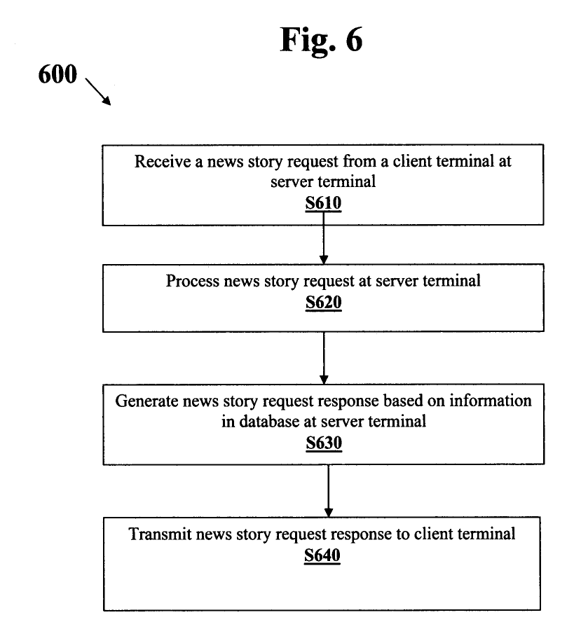

FIG. 6 is a flow diagram illustrating yet another method for document processing, according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Automated document processing with third party input is described. In one embodiment, a corresponding method includes receiving a first document input from a user at a first terminal, and transmitting the first document input to a second terminal. The method also includes receiving, at the second terminal, a second document input from a reviewer based on the first document input, and transmitting information related to the first document input and the second document input to a third terminal. The steps of the method may be embodied in a computer-readable medium, such as software, firmware, or electronic circuitry for example, having stored thereon a program which is executable by a processor. Furthermore, in another embodiment, the method may be implemented using a system that includes a client terminal adapted to receive a first document input from a user, and to transmit the first document input to a server terminal. The system also includes the server terminal communicatively coupled to the client terminal, adapted to receive a second document input from a reviewer based on the first document input, and to transmit information related to the first document input and the second document input to a destination terminal. The methods described herein may refer to methods of doing business, such as a method of filing a patent document with third party input, for example.

FIG. 1 is a flow diagram illustrating a method 100 for document processing, according to an embodiment of the present invention.

Referring to FIG. 1, the method 100 includes receiving a first document input from a user at a first terminal (S110), and transmitting the first document input to a second terminal (S120). The method also includes receiving, at the second terminal, a second document input from a reviewer based on the first document input (S130), and transmitting information related to the first document input and the second document input to a third terminal (S140).

The first document input may be associated with a patent application (e.g., patent document). The method may further include prompting the user for the first document input at the first terminal. That is, the user may be asked to input responses to a question or series of questions, for example. Thus, for example, if the document being processed is a patent document, the user may be asked “What type of document do you wish to file?” and be offered a pull-down menu on the display screen that offers various alternatives such as “Request for Continued Examination” and/or “Information Disclosure Statement”, for example. After selecting a document type, the user may then be asked “What is the patent application serial number?” and/or “What is/are the name(s) of the inventor(s)?” Based upon the user responses to these questions, the first document input is generated for transmission to the second terminal.

The second document input may include a certification of the first document input by the reviewer. In one aspect, the review and/or certification may be performed by a patent agent, an attorney, an accountant, a medical doctor (MD), or other licensed professional. Thus, for example, if the document being processed is a patent document, the certification may include a signature of a patent agent or patent attorney. Alternatively, the review and/or certification may be performed by a reviewer without a special license. The certification may include a certificate of electronic transmission signed by the reviewer. The certificate of electronic transmission may be a certificate of facsimile transmission, for example. The certificate of facsimile transmission may provide certification of the date on which the document was sent, e.g. ‘faxed’, to the United States Patent and Trademark Office (USPTO), for example. As described below, in one aspect of the present invention, the document may be sent via the Internet, yet arrive at its destination terminal as a facsimile (fax). The signature of the reviewer may be input as an electronic signature, for example. That is, the review may not be required to manually write his signature. Instead, the reviewer may input an electronically saved version of his signature, as part of the second document input, for example. In one aspect, the second document input, e.g. electronic signature, may be sent by the reviewer to the second terminal from a fourth terminal.

In one embodiment, different types of patent documents which may be processed include a continued prosecution application (CPA), an amendment, a declaration, a petition, an information disclosure statement (IDS), a terminal disclaimer, a notice of appeal, an appeal brief, a request for continued examination (RCE), an assignment document, an issue fee transmittal, and an authorization to charge a deposit account.

The method may further include processing the first and/or second document inputs before transmission to the third terminal. For example, the first and/or second document inputs may be formatted or reformatted before transmission to the third terminal. Therefore, the method may further include formatting at least one of the first document input and the second document input to generate the information related to the first document input and the second document input before the transmission to the third terminal, for example. Thus, if the document is an IDS, for example, the first document input may be an answer to a question prompted to the user, such as “What US patent would you like to disclose?” The answer provided by the user may be “U.S. Pat. No. ______”, for example. Before transmission to the third terminal, this and other document inputs are formatted into a standard IDS format, such as a USPTO-approved IDS form. Furthermore, the first document input may be formatted or reformatted before it is displayed at the second terminal to the reviewer. The processing of the first and/or second document inputs before the transmission to the third terminal may also include combining the first and second document inputs. For example, data entered by the user at the first terminal may be combined with a signature from the reviewer at the second terminal. In one aspect, the processing of the first and/or second document inputs before transmission to the third terminal generates the information related to the first and second document inputs.

In another embodiment, the second terminal is located in the state of Hawaii, in the United States of America (Hawaii). Furthermore, the third terminal may be affiliated with the US Patent and Trademark Office (USPTO). For example, the third terminal may be located at a USPTO office location in Virginia. Because the second terminal is located in Hawaii, and the third terminal is affiliated with the USPTO, the user may benefit from a later effective filing deadline for the patent document by the inclusion of a certificate of facsimile transmission asserting that the patent document was sent via facsimile to the USPTO before midnight, Hawaii time.

The transmitting of the first document input to the second terminal may be performed using the Internet. Additionally, the transmitting of the information related to the first document input and the second document input to the third terminal may be performed using the Internet. Furthermore, the transmitting of the first document input to the second terminal and the transmitting of the information related to the first document input and the second document input to the third terminal may be performed using the Internet, and the information related to the first document input and the second document input may be received at the third terminal as a facsimile. A technology similar to EFAX® may be used to send a facsimile document via the Internet, for example. In an alternative embodiment, the information related to the first document input and the second document input may be sent to the third terminal using a facsimile machine, or by mail, for example.

FIG. 2 is a block diagram illustrating an exemplary system 200 for performing the methods of the present invention, operating in an exemplary environment 275, according to an embodiment of the present invention.

Referring to FIG. 2, the system 200 includes a client terminal 210 adapted to receive a first document input from a user, and to transmit the first document input to a server terminal 220. The system 200 also includes the server terminal 220 communicatively coupled to the client terminal 210, adapted to receive a second document input from a reviewer based on the first document input, and to transmit information related to the first document input and the second document input to a destination terminal 230.

The system 200 may further include a reviewer terminal 240 communicatively coupled to the server terminal 220, adapted to receive the first document input from the server terminal 220, to receive the second document input from the reviewer based on the first document input, and to transmit the second document input to the server terminal 220 for subsequent transmission with the first document input to the destination terminal 230.

In one embodiment of the present invention, the server terminal 220 is located in an ‘earlier’ time zone than the client terminal 210. For example, the client terminal 210 may be located in New York where the local time is 11:00 pm, Eastern Standard Time (EST), and the server terminal 220 may be located in California, where the local time is 8:00 pm, Pacific Standard Time (PST), or in Hawaii, where the local time is 6:00 pm, Hawaiian-Aleutian Standard Time (HAST). By such an arrangement, the present invention may benefit from the convergence of virtual space, e.g. digital telecommunications, and physical space, e.g., differences in world time zones. Accordingly, the present invention may provide additional time to the end user (user) for the filing of time-critical documents, for example.

In one aspect, the server terminal 220 is located in Hawaii. The destination terminal may be affiliated with the US Patent and Trademark Office (USPTO). The user may be prompted for the first document input at the client terminal. The transmitting of the first document input to the server terminal and the transmitting of the information related to the first document input and the second document input to the destination terminal may be performed using the Internet, and the information related to the first document input and the second document input may be received at the destination terminal as a facsimile.

Although FIG. 2 shows the terminals, e.g. server/client/review/destination terminals, connected via Internet, as indicated by the ‘Internet clouds’ shown in FIG. 2, the terminals may be connected via any type of wired, wireless, and/or satellite network. That is, the system 200 may be implemented in any type of network environment.

FIG. 3 is a block diagram illustrating an exemplary terminal 300 for use in performing the methods of the present invention, according to an embodiment of the present invention.

With reference to FIG. 3, the exemplary terminal 300, such as the client and/or server terminal (e.g., apparatus) includes a processor 310 adapted to process data, a memory 320 adapted to store data for use by the processor, a display 330 adapted to display information to the user and/or reviewer, a user interface 340, such as a mouse and/or keyboard, adapted to receive user inputs, and a network connection 350, such as an Internet connection, to connect the terminals.

In one embodiment, a server apparatus adapted to process a document includes the processor 310 adapted to receive a first document input from a client terminal, to receive a second document input from a reviewer based on the first document input, and to transmit information related to the first document input and the second document input to a destination terminal. The server apparatus also includes the memory 320 operatively coupled to the processor 310, adapted to store the first and second document inputs for use by the processor 310. The server apparatus also includes the display 330 operatively coupled to the processor 310, adapted to display the first document input to the reviewer. The server apparatus also includes the user interface 340 operatively coupled to the processor 310, adapted to receive the second document input from the reviewer based on the first document input displayed on the display 330, and to transfer the second document input to the processor 310. The user interface 340 may include a graphical user interface (GUI), for example. The reception of the first document input from the client terminal, and the transmission of the information related to the first document input and the second document input to the destination terminal may be made using the network connection 350.

The server apparatus may preferably be located in Hawaii. The destination terminal may be affiliated with the US Patent and Trademark Office (USPTO). The processor may be further adapted to format at least one of the first document input and the second document input to generate the information related to the first document input and the second document input before the transmission to the destination terminal.

In another embodiment, the reviewer terminal 240 may be a mobile handheld computing device, such as a PDA or smartphone, for example. The reviewer may thus review the first document input received from the server terminal 220 via the network connection 350, e.g. a wireless network connection, and transmit the second document input, e.g. an electronic signature, to the server terminal 220 via the network connection 350. Upon receiving the second document input from the reviewer terminal 240, the server terminal 220 then processes the first and/or second document inputs to generate the information related to the first and second document inputs for subsequent transmission to the destination terminal 230. In one aspect, the information related to the first and second document inputs may include a template or form containing data entered based upon the first and second document inputs, for example.

Although the present invention is described with several references to processing patent documents, the present invention may also be implemented for processing any type of document needing third party review and/or certification, such as trademark documents, tax documents, real estate documents, court documents, administrative agency documents, medical documents and/or other types of official documents, for example. Furthermore, the present invention may also be utilized to provide document processing, e.g. document filing services with certification, to legal or other professionals working outside of the United States. For example, a US patent attorney working outside of the United States, such as in Europe or Asia, may need a patent document to be filed with the USPTO from within the United States. The patent attorney may submit the first document input at the first terminal. The second document input may be added at the second terminal and the information related to the first and second document inputs may then be transmitted to the third terminal. Thus, the patent document may be filed with the USPTO from within the United States on behalf of the patent attorney working outside of the United States. Additionally, the present invention may also be configured to operate in any country outside of the United States. For example, the server terminal may be located in London, England, while the client terminal is located in Berlin, Germany.

In another preferred embodiment, a database stores news stories from different news outlets for subscriber access. The different news outlets may be news outlets from around the world, such as from each time zone and/or each major city, for example. The news stories may all be translated into a uniform language, such as English, Spanish, Chinese, French, or German, for example. The news stories may be top news stories of the day. The news stories may include world news, national news, regional news, and/or local news, for example. Furthermore, the news stories may include political, legal, business, education, health, science, technology, entertainment, sports, weather, travel and/or human interest stories, for example. The news outlets may include print newspapers, online news publications, televised news broadcasts, and/or radio news broadcasts, for example. In the case of print newspapers, the news stories may include stories from the front page of the print newspaper. In the case of televised or radio news broadcasts, the news broadcasts may be transcribed or left in an audio or audio-visual format. The database may be updated daily from the news outlets. A subscriber may access news stories from one or more news outlets from that day, or may perform an archival search of news stories stored in the database prior to that day.

In another aspect, various search tools are provided to the user. These tools may include perspective search tools, such as a tool that provides the subscriber with a comparison of what news stories are reported in what cities or time zones. The perspective search tools may also provide the user with a comparison of rankings of relative importance of news stories, with respect to different news outlets. To enable the comparison ranking, relative importance rankings may be assigned to each front page story, or each top news story, for example. For example, the comparison may use a 1-5 ranking for the top five most important news stories. A trend mapping tool may also be provided, which maps trends in news reporting, either with respect to one news outlet or multiple news outlets. For example, a trendmapping tool may be utilized to map the change in importance level that a certain news story was given by a certain news outlet over time. Alternatively, the trendmapping could relate to a change in journalistic slant regarding the reporting of a certain news story by one news outlet or a group of news outlets, for example. Additionally, graphical analysis tools may also be provided to graphically display the results found by the search tools, such as the trendmapping tools and/or the perspective tools.

In other words, a news story may be analyzed and/or trendmapped with respect to reporting of the news story by the same news outlet at different times, e.g. different days. Alternatively, the news story may be analyzed and/or trendmapped with respect to reporting of the news story by a different news outlet. The analysis and/or trendmapping may be based on the priority assigned to the news story. The priority may be assigned to the news story based on one or more of the following criteria: story placement, length of story, e.g. number of words, number of reader responses, whether a photo is included with the story, and if so, whether the photo is black & white or color, and amount of advertising revenue derived from the story, for example.

In yet another aspect, the news stories may sorted and categorized by keyword, news type, or other criteria. In still another aspect, access to the database may be provided to the subscriber based on a monthly or annual subscription service. Alternatively, access to the database may be provided to the subscriber on an hourly or other incremental basis.

In yet another preferred embodiment, the database may be utilized to provide timely news reports from one or more news outlets to a user, such as a local or remote user, for example. For example, a user may request the top news story from the other side of the world be provided electronically to a friend. In such case, the database may be searched for the news story having the highest priority in a news outlet from the time zone on the opposite side of the world, or as nearly as possible, for example. Alternatively, the user may request top news stories at the earliest and latest time zone for that day. That is, the top story from news outlets in New Zealand and Hawaii would be provided to the user, for example. Again in the alternative, a user may request a top news story at a particular locale e.g., city of choice for that day. Instead or in addition to requesting a top news story, the user may request a top politics, sports, law or entertainment story, for example, from a particular time zone, locale, or news outlet.

In another aspect, instead or in addition to receiving the requested news story electronically, such as an online certificate (in Adobe PDF® format, for example), the user may receive the requested news story mounted on a plaque, which plaque is shipped to the user. The plaque and/or online certificate may have special appeal to the user for occasions such as a baby's birth, a wedding, a 16^{th} birthday, an 18^{th} birthday, a 21^{st} birthday, or a funeral, for example. The user may be required to make up-front payment for the online certificate or plaque by credit card, for example.

The subscriber and/or user may access the database via a network, such as the Internet or Intranet, for example. The database may be provided in a system which includes a server terminal and a subscriber or client terminal. Referring again to FIG. 3, the server terminal and/or the client terminal may include a processor 310, a memory 320, a display 330, a user interface 340, and a network connection 350. The server terminal may be connected to the news outlets via wired or wireless connections. In the server terminal, the processor 310 may catalogue, prioritize, and assemble database entries. The processor 310 of the server terminal may also perform translation of news stories and/or to perform search tools, for example. The processor 310 may also transcribe radio or television news broadcasts. The memory 320 of the server terminal may be used to store database entries. The network connection 350 of the server terminal may be used to connect to the client terminal and/or the news outlets. News story updates may be received from the news outlets via the network connection 350 and relayed to the processor 310 for processing. After the processing of the news stories by the processor 310, the resulting data is relayed to the memory for storage as a database. The database may then be made accessible to subscribers and/or users who utilize a client terminal to communicate with the server terminal via the network connection, for example.

FIG. 4 is a block diagram illustrating an exemplary system 400′ for performing the methods of the present invention, operating in an exemplary environment 475, according to another embodiment of the present invention. A client terminal 410 is operatively connected to a server terminal, via the Internet for example. The client terminal 410 is adapted to receive user input and generate a news story request, and then transmit the news story request to the server terminal 420. The client terminal 410 is also adapted to receive a news story request response from the server terminal 420. The server terminal 420 is operatively connected to the client terminal and also to news outlet terminals 430 and 435, via the Internet for example. The server terminal 420 is adapted to receive news stories from the news outlet terminals 430 and 435, and to assemble the news stories into a database.

FIG. 5 is a flow diagram illustrating another method 500 for document processing, according to an embodiment of the present invention. At S510, a news story is received from a news outlet terminal at the server terminal. At S520, the news story is processed at the server terminal. At S530, the news story is assembled into a database at the server terminal.

FIG. 6 is a flow diagram illustrating yet another method 600 for document processing, according to an embodiment of the present invention. At S610, a news story request is received from the client terminal at the server terminal. At S620, the news story request is processed at the server terminal. At S630, a news story request response is generated based on information in the database at the server terminal. At S640, the news story request response is transmitted to the client terminal.

The processing by the server terminal may include one or more of the following: prioritizing news stories, trendmapping of news stories, translating news stories into a uniform language, transcribing radio or television news broadcasts, identifying similarities and/or differences in news stories reported across different news outlets, and selecting a top news story from a certain news outlet to be provided to the user as an online certificate and/or plaque, for example.

In one embodiment, a method for processing a document includes receiving a news story request from a client terminal at a server terminal. The method also includes processing the news story request at the server terminal. The method also includes generating a news story request response at the server terminal. The method also includes transmitting news story request response from the server terminal to the client terminal. The processing of the news story request at the server terminal may further include mapping a trend with respect to reporting of a news story by at least one news outlet. The processing of the news story request at the server terminal may further include identifying a similarity with respect to news stories reported across different news outlets. The processing of the news story request at the server terminal may further include identifying a difference with respect to news stories reported across different news outlets. The processing of the news story request at the server terminal may further include selecting a news story from a news outlet to be provided to a user. The news story may be provided to the user as an online certificate. Alternatively, the news story may be provided to the user as a plaque.

In another embodiment, a method for processing a document includes receiving a news story from a news outlet terminal at a server terminal. The method also includes processing the news story at the server terminal. The method also includes incorporating the news story into a database at the server terminal. The processing of the news story at the server terminal may further include assigning a priority to a news story. The processing of the news story at the server terminal may further include translating news stories to a uniform language. The processing of the news story at the server terminal may further include transcribing a news story broadcast on radio or television.

In yet another embodiment, a method for processing a document includes receiving a news story from a news outlet terminal at a server terminal. The method also includes processing the news story at the server terminal. The method also includes incorporating the news story into a database at the server terminal. The method also includes receiving a news story request from a client terminal at the server terminal. The method also includes processing the news story request at the server terminal. The method also includes generating a news story request response at the server terminal based on information stored in the database. The method also includes transmitting news story request response from the server terminal to the client terminal. The processing of the news story request at the server terminal may further include mapping a trend with respect to reporting of a news story by at least one news outlet. The processing of the news story request at the server terminal may further include identifying a similarity with respect to news stories reported across different news outlets. The processing of the news story request at the server terminal may further include identifying a difference with respect to news stories reported across different news outlets. The processing of the news story request at the server terminal may further include selecting a news story from a news outlet to be provided to a user. The news story may be provided to the user as a plaque. The processing of the news story at the server terminal may further include assigning a priority to a news story. The processing of the news story at the server terminal may further include translating news stories to a uniform language. The mapping a trend with respect to reporting of a news story by at least one news outlet may be based on a priority assigned to the news story.

Advantages of the present invention include enabling a third party to provide input, such as review and/or certification, to a document submission. Additionally, if the document is a patent document, and the second terminal is located in Hawaii, the user may benefit from a later effective filing deadline for the patent document by the inclusion of a certificate of facsimile transmission asserting that the patent document was sent via facsimile to the USPTO before midnight, Hawaii Time. Furthermore, a wider range of patent documents may be processed using the present invention than using the EFS. Additionally, because of user prompting and data reformatting, the end user may submit documents through a straightforward question and answer dialog. In addition to patent documents, the present invention may also be utilized to process other types of time-critical, official, legal, medical or other types of documents. Additional advantages of the present invention include the ability to perform analysis on news stories from one or more news outlets.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

1. A method for processing a document, the method comprising:
receiving a news story request from a client terminal at a server terminal;
processing the news story request at the server terminal;
generating a news story request response at the server terminal; and
transmitting news story request response from the server terminal to the client terminal.

2. The method of claim 1, wherein the processing of the news story request at the server terminal further comprises mapping a trend with respect to reporting of a news story by at least one news outlet.

3. The method of claim 1, wherein the processing of the news story request at the server terminal further comprises identifying a similarity with respect to news stories reported across different news outlets.

4. The method of claim 1, wherein the processing of the news story request at the server terminal further comprises identifying a difference with respect to news stories reported across different news outlets.

5. The method of claim 1, wherein the processing of the news story request at the server terminal further comprises selecting a news story from a news outlet to be provided to a user.

6. The method of claim 5, wherein the news story is provided to the user as an online certificate.

7. The method of claim 5, wherein the news story is provided to the user as a plaque.

8. A method for processing a document, the method comprising:
receiving a news story from a news outlet terminal at a server terminal;
processing the news story at the server terminal; and
incorporating the news story into a database at the server terminal.

9. The method of claim 8, wherein the processing of the news story at the server terminal further comprises assigning a priority to a news story.

10. The method of claim 8, wherein the processing of the news story at the server terminal further comprises translating news stories to a uniform language.

11. The method of claim 8, wherein the processing of the news story at the server terminal further comprises transcribing a news story broadcast on radio or television.

12. A method for processing a document, the method comprising:
receiving a news story from a news outlet terminal at a server terminal;
processing the news story at the server terminal;
incorporating the news story into a database at the server terminal;
receiving a news story request from a client terminal at the server terminal;
processing the news story request at the server terminal;
generating a news story request response at the server terminal based on information stored in the database; and
transmitting news story request response from the server terminal to the client terminal.

13. The method of claim 12, wherein the processing of the news story request at the server terminal further comprises mapping a trend with respect to reporting of a news story by at least one news outlet.

14. The method of claim 12, wherein the processing of the news story request at the server terminal further comprises identifying a similarity with respect to news stories reported across different news outlets.

15. The method of claim 12, wherein the processing of the news story request at the server terminal further comprises identifying a difference with respect to news stories reported across different news outlets.

16. The method of claim 12, wherein the processing of the news story request at the server terminal further comprises selecting a news story from a news outlet to be provided to a user.

17. The method of claim 16, wherein the news story is provided to the user as a plaque.

18. The method of claim 12, wherein the processing of the news story at the server terminal further comprises assigning a priority to a news story.

19. The method of claim 12, wherein the processing of the news story at the server terminal further comprises translating news stories to a uniform language.

20. The method of claim 13, wherein the mapping a trend with respect to reporting of a news story by at least one news outlet is based on a priority assigned to the news story.
